(19) United States
(12) Patent Application Publication
(10) Pub. No.: US 2022/0244734 A1
(43) Pub. Date: Aug. 4, 2022

(54) AUTONOMOUS MOBILE SYSTEM, AUTONOMOUS MOBILE METHOD, AND STORAGE MEDIUM

(71) Applicant: TOYOTA JIDOSHA KABUSHIKI KAISHA, Toyota-shi (JP)

(72) Inventors: Tetsuya TAIRA, Nagakute-shi (JP); Shiro ODA, Anjo-shi (JP); Satoshi TOYOSHIMA, Okazaki-shi (JP); Yuta WATANABE, Toyota-shi (JP); Takeshi MATSUI, Nisshin-shi (JP); Takayoshi NASU, Okazaki-shi (JP); Kei YOSHIKAWA, Nagoya-shi (JP); Yusuke OTA, Nagakute-shi (JP); Yutaro ISHIDA, Toyota-shi (JP); Yuji ONUMA, Nagoya-shi (JP)

(21) Appl. No.: 17/517,992

(22) Filed: Nov. 3, 2021

(30) Foreign Application Priority Data
Feb. 1, 2021 (JP) 2021-014463

(51) Int. Cl. G05D 1/02

(52) U.S. Cl. CPC G05D 1/0214; G05D 1/0238; G05D 2201/0216; G05D 1/0274; G05D 1/0223

(57) ABSTRACT

An autonomous mobile system according to the present embodiment includes: obstacle detection means for detecting an obstacle in an aisle; distance measurement means for measuring a distance from the obstacle; obstacle determination means for determining a kind of the obstacle; and storage means for storing a predetermined distance set according to the kind of the obstacle. The autonomous mobile system travels with the predetermined distance from the obstacle depending on the kind of the obstacle.

### CROSS-REFERENCE TO RELATED APPLICATION

This application claims priority to Japanese Patent Application No. 2021-014463 filed on Feb. 1, 2021, incorporated herein by reference in its entirety.

### BACKGROUND

### 1. Technical Field

The present disclosure relates to an autonomous mobile system, an autonomous mobile method, and a storage medium.

### 2. Description of Related Art

Development of autonomous mobile devices that autonomously move within a predetermined building or facility is in progress. Such an autonomous mobile device having a loading platform can serve as an automatic delivery device that automatically delivers a package. The automatic delivery device can, for example, deliver the package loaded at the departure point to the destination by autonomously moving from the departure point to the destination.

For example, in the range where the autonomous mobile robot travels, it is conceivable that there are places where people actually pass and it is not preferable to approach, such as obstacles and stairs. Japanese Unexamined Patent Application Publication No. 2010-176203 (JP 2010-176203 A) discloses an autonomous mobile robot that includes a mark detector for detecting a mark for safety confirmation, environmental information acquisition means, position information acquisition means, and storage means for storing self-position information, map information, and control parameters. When there is no mark indicating a safe area, the autonomous mobile robot regards the area as a dangerous area and stops moving.

### SUMMARY

Points with a high probability of being used by people, such as handrails, are also considered to be unpreferable places for autonomous mobile robots to travel. However, in order to avoid interference with such a point, traveling in a large detour may reduce work efficiency depending on the purpose of the robot such as transportation.

The present disclosure has been made to solve the issue described above, and provides an autonomous mobile system, an autonomous mobile method, and a storage medium capable of improving movement efficiency of the mobile robot.

An autonomous mobile system according to the present embodiment is an autonomous mobile system that autonomously moves in a facility. The autonomous mobile system includes: obstacle detection means for detecting an obstacle in an aisle; distance measurement means for measuring a distance from the obstacle; obstacle determination means for determining a kind of the obstacle; and storage means for storing the predetermined distance set according to the kind of the obstacle. The autonomous mobile system travels with the predetermined distance from the obstacle depending on the kind of the obstacle. With such a configuration, the movement efficiency of the mobile robot can be improved.

An autonomous mobile system according to the present embodiment includes an autonomous mobile device that autonomously moves in a facility. When there is an obstacle in an aisle where the autonomous mobile device travels, the autonomous mobile device travels with a predetermined distance set according to a kind of the obstacle, from the obstacle. With such a configuration, the movement efficiency of the mobile robot can be improved.

The above autonomous mobile system further includes a server device that transmits and receives traveling information to and from the autonomous mobile device. The server device includes, of the autonomous mobile system, at least one of: obstacle detection means for detecting the obstacle in the aisle; distance measurement means for measuring a distance from the obstacle; obstacle determination means for determining the kind of the obstacle; and storage means for storing the predetermined distance set according to the kind of the obstacle. With such a configuration, the movement efficiency of the mobile robot can be improved while suppressing the interference with the obstacle.

In the above autonomous mobile system, the obstacle is an installed object installed in the aisle to be used by a person, and the predetermined distance is a distance for the person to use the installed object. With such a configuration, the movement efficiency of the mobile robot can be improved while suppressing the interference with the installed object.

In the above autonomous mobile system, the installed object includes at least one of a handrail, a bench, and a bulletin board. With such a configuration, the movement efficiency of the mobile robot can be improved while suppressing the interference with a handrail, a bench, a bulletin board, and the like.

In the above autonomous mobile system, when detecting the person who uses the installed object, the autonomous mobile system changes a speed of autonomous movement. With such a configuration, it is possible to suppress the interference with a person who uses the installed object.

In the above autonomous mobile system, when a predetermined moving body approaches and the autonomous mobile system does not detect the person who uses the installed object, the autonomous mobile system travels with a smaller distance from the installed object than the predetermined distance. With such a configuration, the movement efficiency of the mobile robot can be further improved.

An autonomous mobile method according to the present embodiment is an autonomous mobile method for an autonomous mobile device that autonomously moves in a facility provided with an aisle. The autonomous mobile method includes: a step of determining a kind of an obstacle when the autonomous mobile device detects the obstacle in the aisle where the autonomous mobile device travels; a step of preparing a predetermined distance set according to the kind of the obstacle; and a step of traveling with the predetermined distance from the obstacle. With such a configuration, the movement efficiency of the mobile robot can be improved.

A storage medium according to the present embodiment stores an autonomous mobile program for an autonomous mobile device that autonomously moves in a facility provided with an aisle. The autonomous mobile program causes a computer to execute: determination of a kind of an obstacle when the autonomous mobile device detects the obstacle in the aisle where the autonomous mobile device travels; preparation of a predetermined distance set according to the kind of the obstacle; and traveling with the predetermined distance from the obstacle. With such a configuration, the movement efficiency of the mobile robot can be improved.

The present embodiment can provide an autonomous mobile system, an autonomous mobile method, and a storage medium capable of improving the movement efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a mobile robot according to a first embodiment;

FIG. 2 is a perspective view illustrating the mobile robot according to the first embodiment;

FIG. 3 is a block diagram illustrating the mobile robot according to the first embodiment;

FIG. 4 is a plan view illustrating a movement method of the mobile robot in a facility according to the first embodiment;

FIG. 5 is a plan view illustrating the movement method of the mobile robot in the facility according to the first embodiment;

FIG. 6 is a flowchart illustrating the movement method of the mobile robot in the facility according to the first embodiment;

FIG. 7 is a flowchart illustrating a movement method of the mobile robot in the facility according to a first modification of the first embodiment;

FIG. 8 is a flowchart illustrating a movement method of the mobile robot in the facility according to a second modification of the first embodiment;

FIG. 9 is a flowchart illustrating a movement method of the mobile robot in the facility according to a third modification of the first embodiment;

FIG. 10 is a block diagram illustrating a server device according to a second embodiment;

FIG. 11 is a sequence diagram illustrating a movement method of a mobile robot in a facility according to the second embodiment;

FIG. 12 is a sequence diagram illustrating a movement method of the mobile robot in the facility according to a first modification of the second embodiment;

FIG. 13 is a sequence diagram illustrating a movement method of the mobile robot in the facility according to a second modification of the second embodiment; and

FIG. 14 is a sequence diagram illustrating a movement method of the mobile robot in the facility according to a third modification of the second embodiment.

### DETAILED DESCRIPTION OF EMBODIMENTS

Hereinafter, the present disclosure will be described through embodiments of the disclosure, but the disclosure is not limited to the following embodiments. Moreover, not all of the configurations described in the embodiments are indispensable as means for solving the problem. For the sake of clarity, the following description and drawings have been omitted and simplified as appropriate. In each drawing, the same elements are designated by the same reference signs, and duplicate descriptions are omitted as necessary.

### First Embodiment

An autonomous mobile system according to a first embodiment will be described. In the present embodiment, the autonomous mobile system may be replaced with an autonomous mobile device, or the autonomous mobile device may be replaced with the autonomous mobile system. Further, the autonomous mobile system according to the present embodiment may include the autonomous mobile device. The autonomous mobile device autonomously moves in a predetermined facility. The autonomous mobile device may be, for example, a mobile robot that autonomously moves, or a transportation robot that autonomously moves to transport an object. Hereinafter, the mobile robot will be described as an example of the autonomous mobile device. The mobile robot will be described separately in “Structure of Mobile Robot” and “Operation of Mobile Robot”.

Structure of Mobile Robot

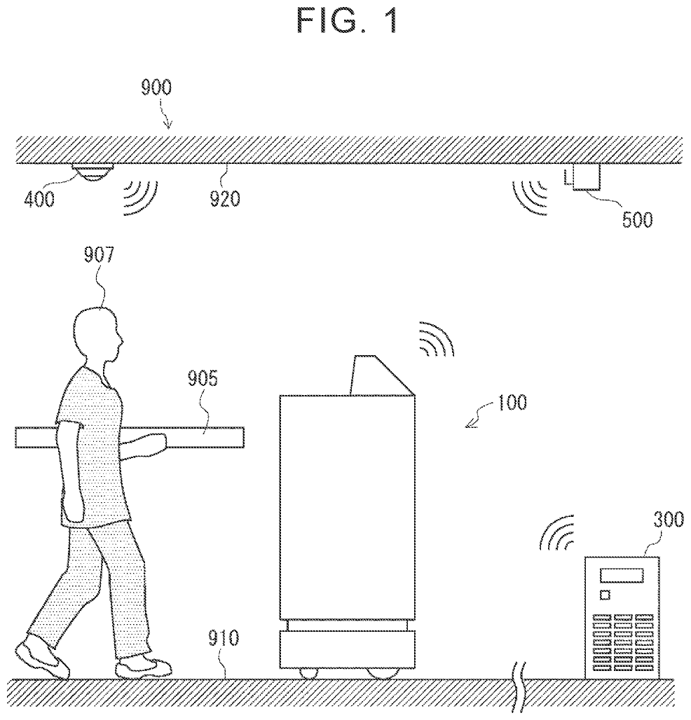

FIG. 1 is a schematic view illustrating the mobile robot according to the first embodiment. As shown in FIG. 1, a mobile robot 100 is an example of the autonomous mobile device that autonomously moves in a predetermined facility 900. The predetermined facility 900 is, for example, a hospital. The predetermined facility 900 is not limited to a hospital, and may be a hotel, a shopping mall, or the like as long as the mobile robot 100 can move autonomously in the predetermined facility 900. An installed object 905 such as a handrail is installed in the facility 900. The installed object 905 is used by a person 907.

The mobile robot 100 autonomously moves on a floor surface 910 in the facility 900. A facility camera 400 is fixed in the facility 900. For example, the facility camera 400 is fixed to a ceiling 920 of the facility 900, and captures images of surrounding areas of the facility camera 400 to generate image data. The facility camera 400 captures images of, for example, an aisle, a corner, a passerby, another mobile robot 100, and the like. A plurality of the facility cameras 400 may be provided in the facility 900.

The mobile robot 100 and the facility camera 400 are connected to each other so as to be able to communicate with each other via information transmission means such as wireless communication. The mobile robot 100 and the facility camera 400 may be connected to each other so as to be able to directly communicate with each other, or may be connected to each other so as to be able to communicate with each other via an access point 500 and a server device 300. Therefore, the mobile robot 100 may acquire the image data directly from the facility camera 400, or may acquire the image data via the access point 500 and the server device 300.

The access point 500 is, for example, a wireless local area network (LAN) access point. The access point 500 is fixed in the facility 900 and acquires position information, traveling information, and the like from the mobile robot 100 located in the periphery of the access point 500. A plurality of the access points 500 may be provided in the facility 900.

A plurality of the mobile robots 100 may autonomously move in the facility 900. When the mobile robots 100 autonomously move, the mobile robots 100 may be connected to each other so as to be able to communicate with each other via information transmission means such as wireless communication. The mobile robots 100 may be connected to each other so as to be able to directly communicate with each other, or may be connected to each other so as to be able to communicate with each other via the access point 500 and the server device 300.

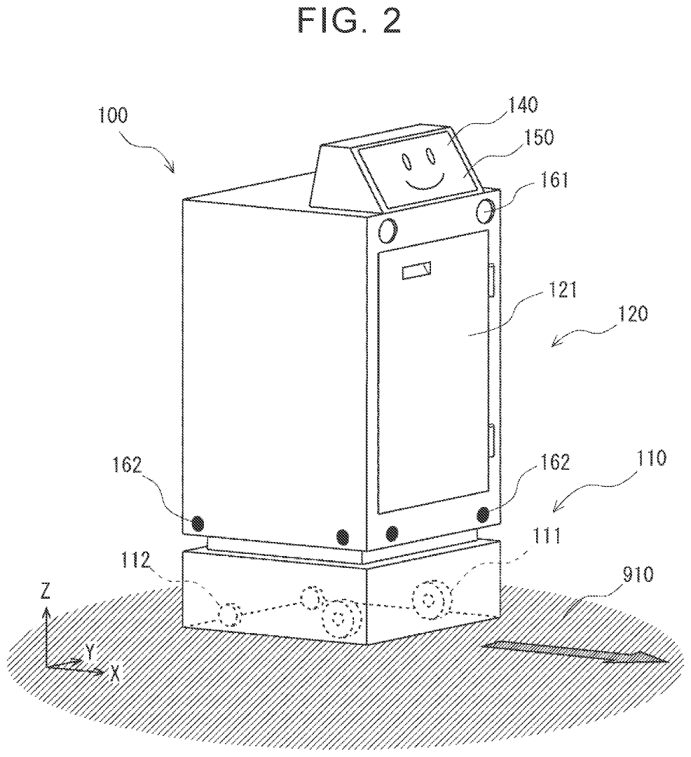

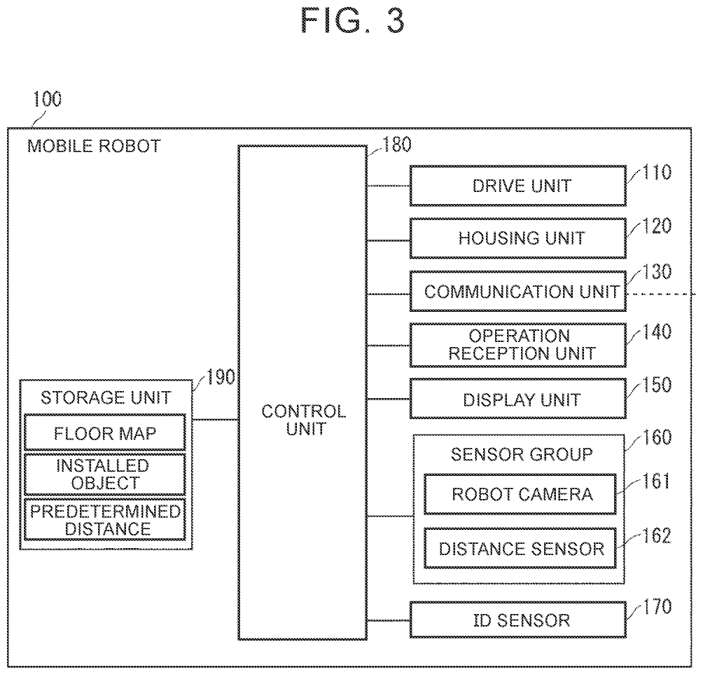

FIG. 2 is a perspective view illustrating the mobile robot 100 according to the first embodiment. FIG. 3 is a block diagram illustrating the mobile robot 100 according to the first embodiment. As shown in FIGS. 2 and 3, the mobile robot 100 includes a drive unit 110, a housing unit 120, a communication unit 130, an operation reception unit 140, a display unit 150, a sensor group 160, an identification (ID) sensor 170, a control unit 180, and a storage unit 190.

As shown in FIG. 2, the mobile robot 100 is a moving body that moves on the floor surface 910 that is a moving surface. Here, for convenience of explanation of the mobile robot 100, the XYZ orthogonal coordinate axis system is used. The floor surface 910 is the XY-plane, and the upper side is the +Z axis direction.

The drive unit 110 functions as means for moving the mobile robot 100. The drive unit 110 includes two drive wheels 111 that are in contact with the floor surface 910 and are rotatable independently from each other about one rotation axis that extends in a direction (right-left direction or Y-axis direction in the drawing) perpendicular to a straight direction (front-rear direction or X-axis direction in the drawing), and casters 112 in contact with the floor surface 910. The mobile robot 100 moves forward or rearward in a manner such that the drive wheels 111 disposed on the right and left sides are driven at the same rotation speed, and makes a turn by generating a difference in the rotation speed or rotation direction between the right and left drive wheels 111. The drive unit 110 drives the drive wheels 111 in accordance with commands from the control unit 180.

The housing unit 120 is disposed above the drive unit 110 of the mobile robot 100. The housing unit 120 may have a storage chamber door 121. In this case, the housing unit 120 functions as storage means for objects. When the storage chamber door 121 is opened, a storage chamber for storing a predetermined object is provided inside the housing unit 120. That is, the mobile robot 100 can also be a transportation robot that transports a predetermined object. The housing unit 120 may open and close the storage chamber door 121 in accordance with a command from the control unit 180.

As shown in FIG. 3, the communication unit 130 is an interface that is communicably connected to the outside. Thus, the communication unit 130 functions as communication means. The communication unit 130 includes, for example, an antenna and a circuit that modulates or demodulates a signal transmitted through the antenna. The communication unit 130 receives the image data directly from the facility camera 400 or via the access point 500 and the server device 300.

Further, the communication unit 130 may receive information related to the destination, the position information, the traveling information and the like from the server device 300. Further, the communication unit 130 may transmit information related to the state of the mobile robot 100, the position information, the traveling information, and the like to the server device 300. Further, the communication unit 130 may transmit and receive the position information and the image data to and from the other mobile robot 100 directly or via the access point 500 and the server device 300.

The communication unit 130 may periodically transmit a heartbeat signal to the server device 300. The heartbeat signal may include log data indicating the state of the mobile robot 100 in the chronological order. Further, the heartbeat signal may include the ID of the mobile robot 100 and the ID of a user.

The communication unit 130 connects to the control unit 180, outputs, to the control unit 180, a signal including information transmitted from the facility camera 400 and the server device 300, and transmits, to the server device 300, the signal including the information output from the control unit 180.

The operation reception unit 140 receives an input operation from the user and transmits an operation signal to the control unit 180. As means for receiving an input operation from the user, the operation reception unit 140 may include, for example, an operation button, a touch panel superimposed on the display unit 150, or the like. The user operates the input operation means described above to turn on and off the power supply, open and close the storage chamber door 121, and the like.

The display unit 150 is provided, for example, so as to project from the upper surface of the housing unit 120. The display unit 150 is, for example, a display unit including a rectangular liquid crystal panel. The display unit 150 appropriately displays information in accordance with the command from the control unit 180. The display unit 150 functions as display means for information. A touch panel that receives operations from the user may be superimposed on the display unit 150.

The sensor group 160 includes sensors that acquire data necessary for the mobile robot 100 to move autonomously. The sensor group 160 functions as obstacle detection means for detecting an obstacle in the aisle. The sensor group 160 also functions as distance measurement means for measuring a distance from an obstacle in the aisle. The sensor group 160 includes, for example, a robot camera 161 and a distance sensor 162. The sensor group 160 may appropriately include sensors other than the robot camera 161 and the distance sensor 162.

The robot camera 161 is disposed in an upper portion of the housing unit 120 and below the display unit 150, for example. In the robot camera 161, two camera units having the same angle of view may be disposed horizontally separated from each other. With this configuration, the images captured by each camera unit are output to the control unit 180 as the image data.

The distance sensor 162 is disposed, for example, in the lower portion of the housing unit 120. The distance sensor 162 may be disposed in the lower portion of each of a surface on the +X-axis direction side, a surface on the −X-axis direction side, a surface on the +Y-axis direction side, and a surface on the −Y-axis direction side of the housing unit 120. The distance sensor 162 measures the distance between an object around the mobile robot 100 and the mobile robot 100. The control unit 180 recognizes the obstacle around the mobile robot 100 by analyzing the image data output by the robot camera 161 and the detection signals output by the distance sensor 162, and measures the distance between the mobile robot 100 and the obstacle.

The ID sensor 170 is provided, for example, near the display unit 150. The ID sensor 170 identifies the ID of the user who operates the mobile robot 100, and detects a unique identifier included in the ID card owned by each user. The ID sensor 170 includes, for example, an antenna for reading information on a wireless tag. The user brings the ID card close to the ID sensor 170 such that the mobile robot 100 is caused to recognize the ID of the user who is the operator.

The control unit 180 is an information processing device including an arithmetic device such as a central processing unit (CPU). The control unit 180 includes hardware (an example of a storage medium) provided in the control unit 180 and a program stored in the hardware. That is, processes executed by the control unit 180 are realized by either hardware or software.

The control unit 180 acquires various types of information from each configuration and issues a command to each configuration in accordance with the acquired information. For example, the control unit 180 detects the distance between the mobile robot 100 and the surrounding object from the image data acquired from the robot camera 161 and the information on the object around the mobile robot 100 acquired from the distance sensor 162. Then, the control unit 180 calculates a route to the destination from the detected distance, and commands the drive unit 110 to move along the route in accordance with the calculated route. When executing such a process, the control unit 180 refers to information related to a floor map stored in the storage unit 190. Further, the control unit 180 determines the kind of the obstacle in the aisle where the mobile robot 100 travels. For example, the control unit 180 recognizes the characteristics of the obstacle detected by the sensor group 160 to determine the kind of the obstacle. Thus, the control unit 180 functions as obstacle determination means for determining the kind of the obstacle.

The storage unit 190 includes a non-volatile memory such as a flash memory and a solid state drive (SSD). The storage unit 190 stores the floor map of the facility used by the mobile robot 100 for autonomous movement. The storage unit 190 also stores information on the obstacle and the installed object 905. The storage unit 190 also stores a predetermined distance 906 set according to the kind of the obstacle and the installed object 905. The predetermined distance 906 is a distance set according to the kind of the obstacle and is a distance between the obstacle and the mobile robot 100 that travels. Thus, the storage unit 190 functions as storage means. The storage unit 190 is connected to the control unit 180, and outputs stored information to the control unit 180 in response to a request from the control unit 180.

As shown in FIG. 2, the mobile robot 100 has the +X-axis direction side on which the robot camera 161 is installed as the front. That is, during normal movement, the traveling direction is the +X-axis direction as shown by the arrow.

Various ideas can be adopted for how to define the front of the mobile robot 100. For example, the front can be defined based on how the sensor group 160 for recognizing the surrounding environment is disposed. Specifically, the +X-axis direction side of the housing unit 120 on which the sensor having high recognition ability is disposed or many sensors are disposed can be set as the front. By defining the front as described above, the mobile robot 100 can move while recognizing the surrounding environment more accurately. The mobile robot 100 according to the present embodiment also has the +X-axis direction side on which the robot camera 161 is disposed as the front.

Alternatively, the front can be defined based on how the display unit 150 is disposed. When the display unit 150 displays the face of the character or the like, the surrounding people naturally recognize that the display unit 150 is the front of the mobile robot 100. Therefore, when the display surface side of the display unit 150 is set as the front, there is little discomfort to the surrounding people. The mobile robot 100 according to the present embodiment also has the display surface side of the display unit 150 as the front.

Further, the front may be defined based on a shape of the housing of the mobile robot 100. For example, when the projected shape of the housing unit 120 on the traveling surface is rectangular, it is better to have the short side as the front than the longitudinal side as the front, whereby people who pass by the mobile robot 100 are not obstructed during moving. That is, depending on the shape of the housing, there is a housing surface that is preferably set as the front when the mobile robot 100 moves normally. The mobile robot 100 according to the present embodiment has the short side of the rectangular shape as the front. As described above, for the mobile robot 100, the front is defined so as to match some ideas. However, the idea used to define the front may be determined in consideration of the shape and role of the mobile robot.

Operation of Mobile Robot

Next, the operation of the mobile robot according to the present embodiment will be described. For example, the user turns on the power supply of the mobile robot 100. Then, the user inputs a desired task to the operation reception unit 140. When necessary, the ID sensor 170 identifies the ID of the user when the power supply is turned on or when the user operates the operation reception unit 140.

In order to transport the object as a desired task, the user operates the operation reception unit 140 to open the storage chamber door 121 and store the object in the storage chamber. Then, the user operates the operation reception unit 140 to close the storage chamber door 121. Next, the user inputs the destination of the object using the operation reception unit 140. The control unit 180 of the mobile robot 100 searches for a route to the destination using the floor map stored in the storage unit 190. The mobile robot 100 autonomously moves along the searched route.

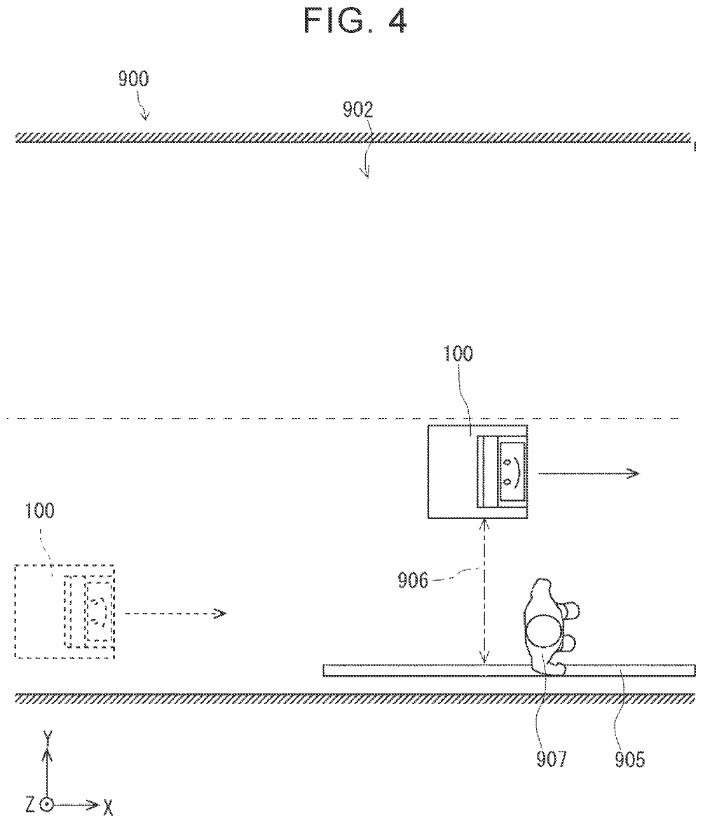

FIG. 4 is a plan view illustrating a movement method of the mobile robot 100 in the facility 900 according to the first embodiment. As shown in FIG. 4, the facility 900 is provided with an aisle 902 extending in the X-axis direction. The installed object 905 installed to be used by the person 907 is provided at a predetermined position in the aisle 902. The installed object 905 is, for example, a handrail. Note that the installed object 905 is not limited to a handrail. For example, the installed object 905 may be any object installed to be used by the person 907, such as a bench and a bulletin board.

The mobile robot 100 moves in the aisle 902 from the −X-axis direction side to the +X-axis direction side. The mobile robot 100 basically travels alongside the wall. This suppresses the mobile robot 100 from obstructing the person 907 and other mobile robots 100 that move in the aisle 902. When there is an obstacle in the aisle 902 where the mobile robot 100 travels, the mobile robot 100 travels with the predetermined distance 906 set according to the kind of the obstacle, from the obstacle. The obstacle is, for example, the installed object 905 installed in the aisle 902 to be used by the person 907. The predetermined distance 906 is a distance provided for the person 907 to use the installed object 905, and is set according to the kind of the installed object 905.

For example, when the installed object 905 is a handrail, the predetermined distance 906 is a distance at which the mobile robot 100 does not interfere with the person 907 who is walking while holding the handrail. When the installed object 905 is a bench, the predetermined distance 906 is a distance at which the mobile robot 100 does not interfere with the person 907 seated on the bench. When the installed object 905 is a bulletin board, the predetermined distance 906 is a distance at which the mobile robot 100 does not interfere with the person 907 who is looking at the bulletin board.

The obstacle is not limited to the installed object 905, and may be a moving body that moves such as another mobile robot 100 and a stretcher. Even in this case, the predetermined distance 906 may be set according to the kind of the obstacle.

The mobile robot 100 may detect the obstacle such as the installed object 905 by the robot camera 161, or may detect the obstacle from the floor map stored in the storage unit 190 in advance. Alternatively, the mobile robot 100 may detect the obstacle from the image data captured by the facility camera 400. The image data may be transmitted directly from the facility camera 400 or may be transmitted via the server device 300 and the access point 500.

When the mobile robot 100 traveling alongside the wall detects the installed object 905, the mobile robot 100 travels with the predetermined distance 906 from the installed object 905. As a result, it is possible to suppress the interference between the mobile robot 100 and the person 907 who uses the installed object 905. Further, since the mobile robot 100 does not have to make a large detour, the movement efficiency can be improved.

When the mobile robot 100 detects the installed object 905, the mobile robot 100 may travel with the predetermined distance 906 regardless of whether the person 907 who uses the installed object 905 is detected or the person 907 who uses the installed object 905 is not detected. Further, the configuration may be such that the mobile robot 100 travels with the predetermined distance 906 when the mobile robot 100 detects the installed object 905 and the person 907 who uses the installed object 905, and the mobile robot 100 does not secure the predetermined distance 906 when the mobile robot 100 detects only the installed object 905.

The mobile robot 100 may change the speed of the autonomous movement when the mobile robot 100 detects the person 907 who uses the installed object 905. As a result, it is possible to further suppress the interference between the mobile robot 100 and the person 907 who uses the installed object 905.

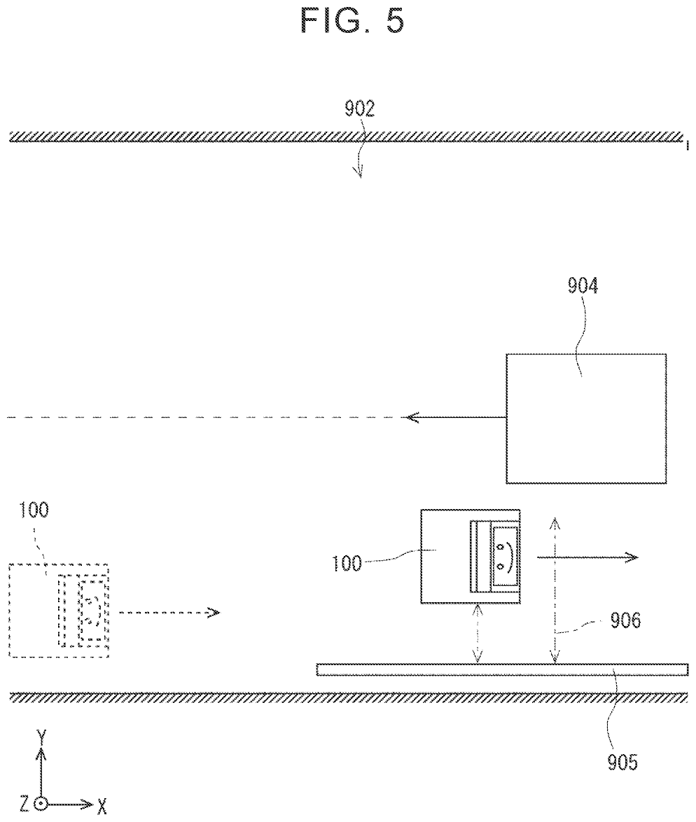

FIG. 5 is a plan view illustrating a movement method of the mobile robot 100 in the facility 900 according to the first embodiment. As shown in FIG. 5, for example, the mobile robot 100 may travel with a smaller distance from the installed object 905 than the predetermined distance 906 when a predetermined moving body 904 approaches and the mobile robot 100 does not detect the person 907 who uses the installed object 905. As a result, the movement efficiency of the mobile robot 100 can be further improved while ensuring the traveling safety of the mobile robot 100.

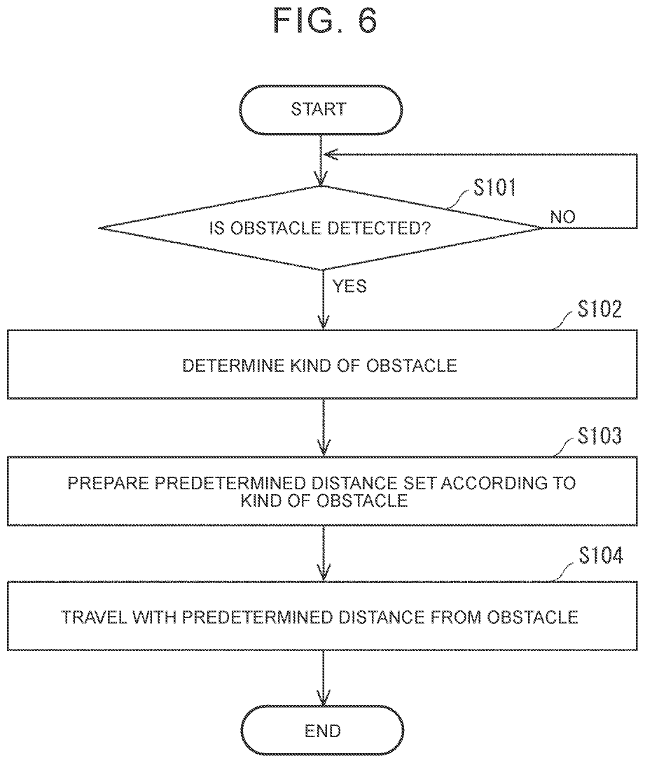

Next, the operation of the mobile robot 100 described above will be described with reference to a flowchart. FIG. 6 is a flowchart illustrating a movement method of the mobile robot 100 in the facility 900 according to the first embodiment. As shown in step S101 of FIG. 6, the mobile robot 100 determines whether an obstacle has been detected. For example, the control unit 180 of the mobile robot 100 determines whether the sensor group 160 has detected the obstacle in the aisle 902. In step S101, when the obstacle has not been detected, step S101 is repeated.

In contrast, when the mobile robot 100 has detected an obstacle in step S101, the mobile robot 100 determines the kind of the obstacle as shown in step S102. For example, the control unit 180 of the mobile robot 100 determines the kind of the obstacle from the information on the obstacle detected by the sensor group 160. For example, the control unit 180 determines the kind of the obstacle from the image of the obstacle captured by the robot camera 161.

Next, as shown in step S103, the mobile robot 100 prepares the predetermined distance 906 set according to the kind of the obstacle. For example, the control unit 180 obtains the predetermined distance 906 set according to the kind of the obstacle from the storage unit 190. The predetermined distance 906 may be stored in the storage unit 190 in advance.

Subsequently, as shown in step S104, the mobile robot 100 travels with the predetermined distance 906 from the obstacle. According to the present embodiment, the mobile robot 100 can improve the movement efficiency while suppressing the interference with the obstacle. The mobile robot 100 may change the speed of the autonomous movement of the mobile robot 100 when traveling with the predetermined distance 906 from the obstacle. For example, the mobile robot 100 may lower the speed compared to the speed when traveling in an aisle without any obstacles.

### First Modification of First Embodiment

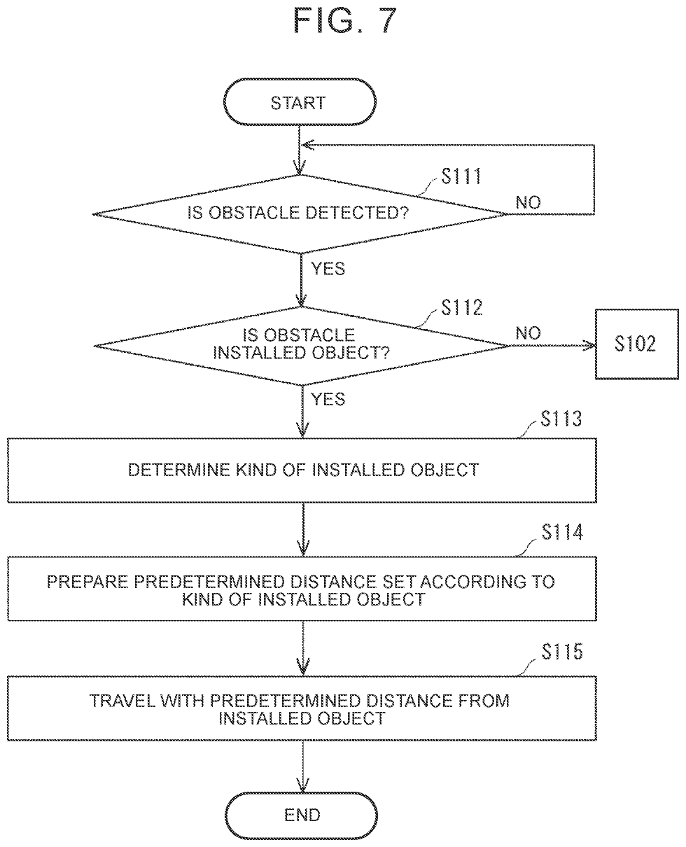

Next, a first modification will be described. The first modification is an example in which the obstacle is the installed object 905. FIG. 7 is a flowchart illustrating a movement method of the mobile robot 100 in the facility 900 according to the first modification of the first embodiment.

As shown in step S111 of FIG. 7, the mobile robot 100 determines whether an obstacle has been detected. In step S111, when the obstacle has not been detected, step S111 is repeated.

In contrast, when the mobile robot 100 has detected an obstacle in step S111, the mobile robot 100 determines whether the obstacle is the installed object 905 as shown in step S112. For example, the control unit 180 of the mobile robot 100 determines whether the obstacle is the installed object 905 from the information on the obstacle detected by the sensor group 160. When the obstacle is not the installed object 905 in step S112, the process proceeds to step S102 of FIG. 6 described above, and steps S102 to S104 are executed.

In contrast, when the obstacle is the installed object 905 in step S112, the kind of the installed object 905 is determined as shown in step S113. For example, the control unit 180 of the mobile robot 100 determines the kind of the installed object 905 from the information on the installed object 905 detected by the sensor group 160.

Next, as shown in step S114, the mobile robot 100 prepares the predetermined distance 906 set according to the kind of the installed object 905. For example, the control unit 180 obtains the predetermined distance 906 set according to the kind of the installed object 905 from the storage unit 190. The predetermined distance 906 may be stored in the storage unit 190 in advance. For example, when the installed object 905 is a handrail, the predetermined distance 906 is a distance at which the mobile robot 100 does not obstruct the person 907 who walks while holding the handrail.

Subsequently, as shown in step S115, the mobile robot 100 travels with the predetermined distance 906 from the installed object 905. According to the present modification, it is possible to improve the movement efficiency of the mobile robot 100 while ensuring the safety of the person who uses the installed object 905.

### Second Modification of First Embodiment

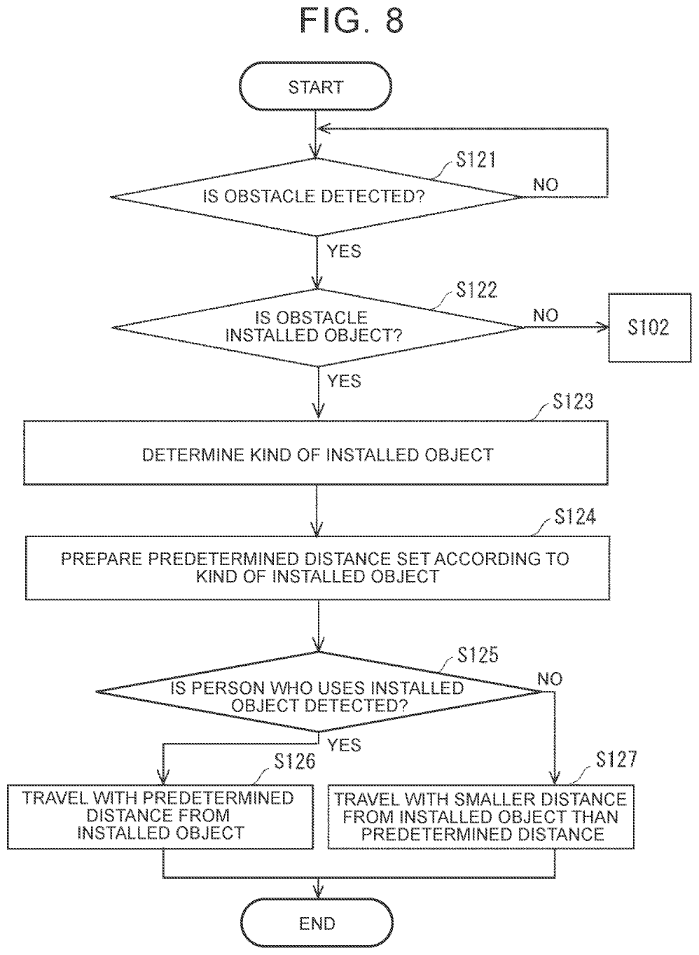

Next, a second modification will be described. The second modification is a method of distinguishing the case where there is a person 907 who uses the installed object 905 and the case where there is no person 907 who uses the installed object 905, when the obstacle is the installed object 905. FIG. 8 is a flowchart illustrating a movement method of the mobile robot 100 in the facility 900 according to the second modification of the first embodiment.

Steps S121 to S124 of FIG. 8 are the same as steps S111 to S114 described above.

Next, as shown in step S125, it is determined whether a person who uses the installed object 905 has been detected. For example, the control unit 180 of the mobile robot 100 determines whether a person who uses the installed object 905 has been detected from the information on the installed object 905 detected by the sensor group 160. When a person who uses the installed object 905 has been detected in step S125, the mobile robot 100 travels with the predetermined distance 906 from the installed object 905 as shown in step S126.

In contrast, when a person who uses the installed object 905 has not been detected in step S125, the mobile robot 100 travels with a smaller distance from the installed object 905 than the predetermined distance 906 as shown in step S127. According to the present modification, it is possible to improve the movement efficiency while ensuring the safety of the person who uses the installed object 905.

### Third Modification of First Embodiment

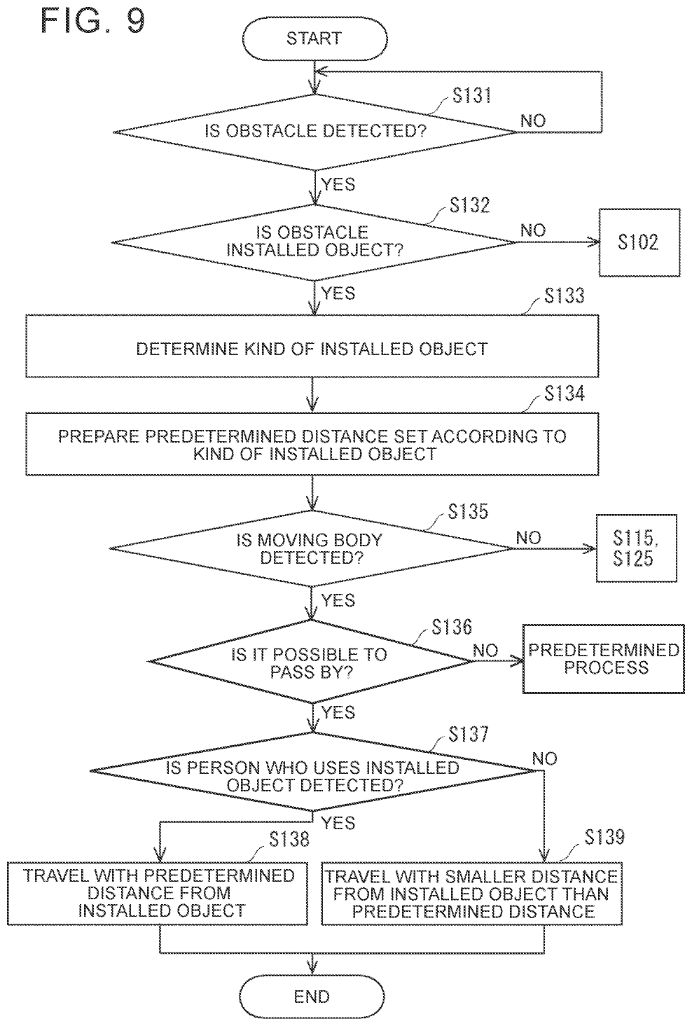

Next, a third modification will be described. The third modification is a method of passing by the moving body 904 when the obstacle is the installed object 905. FIG. 9 is a flowchart illustrating a movement method of the mobile robot 100 in the facility 900 according to the third modification of the first embodiment.

Steps S131 to S134 of FIG. 9 are the same as steps S111 to S114 described above.

Next, as shown in step S135, it is determined whether the moving body 904 has been detected. For example, the control unit 180 of the mobile robot 100 determines whether the sensor group 160 has detected the moving body 904. When the moving body 904 has not been detected in step S135, the process proceeds to step S115 or step S125.

In contrast, when the moving body 904 has been detected in step S135, the mobile robot 100 determines whether it is possible to pass by the moving body 904 as shown in step S136. In step S136, when the mobile robot 100 cannot pass by the moving body 904, the mobile robot 100 performs a predetermined process. For example, the mobile robot 100 may stop at the edge of the aisle 902, or may go back in the aisle 902.

In contrast, when it is possible to pass by the moving body 904 in step S136, it is determined whether a person 907 who uses the installed object 905 has been detected as shown in step S137. For example, the control unit 180 of the mobile robot 100 determines whether a person 907 who uses the installed object 905 has been detected from the information on the installed object 905 detected by the sensor group 160. When a person 907 who uses the installed object 905 has been detected in step S137, the mobile robot 100 travels with the predetermined distance 906 from the installed object 905 as shown in step S138.

In contrast, when a person 907 who uses the installed object 905 has not been detected in step S137, the mobile robot 100 travels with a smaller distance from the installed object 905 than the predetermined distance 906 as shown in step S139.

As described above, in the third modification, the mobile robot 100 travels with a smaller distance from the installed object 905 than the predetermined distance 906 when a predetermined moving body 904 approaches and the mobile robot 100 does not detect the person 907 who uses the installed object 905. According to the present modification, even when the moving body 904 passes by, the movement efficiency can be improved while ensuring the safety of the person 907 who uses the installed object 905.

### Second Embodiment

Next, an autonomous mobile system according to a second embodiment will be described. The autonomous mobile system according to the present embodiment is a system that controls an autonomous mobile device that autonomously moves in the predetermined facility 900. The autonomous mobile system will be described separately in “Configuration of Autonomous Mobile System” and “Operation of Autonomous Mobile System”.

Configuration of Autonomous Mobile System

The autonomous mobile system includes the mobile robot 100. The autonomous mobile system may include a plurality of the mobile robots 100. Further, the autonomous mobile system may include the server device 300 and the facility camera 400 in addition to the mobile robot 100.

Mobile Robot

The configuration of the mobile robot 100 according to the present embodiment is the same as that of the first embodiment described above. The mobile robot 100 according to the present embodiment may cause the server device 300 to execute some of the functions of the mobile robot 100 according to the first embodiment.

For example, the communication unit 130 may transmit the information on the obstacle detected by the sensor group 160 to the server device 300. Then, the communication unit 130 may receive the information on the kind of the obstacle and the information on the predetermined distance 906 set according to the kind of the obstacle from the server device 300.

Server Device

The server device 300 is, for example, a computer having a communication function. The server device 300 may be installed at any place as long as the server device 300 can communicate with each configuration of the autonomous mobile system. The server device 300 may transmit and receive the traveling information to and from the mobile robot 100, and may acquire the image data from the facility camera 400. The server device 300 may include, for example, at least one of the obstacle detection means, the distance measurement means, the obstacle determination means, and the storage means of the mobile robot 100 of the first embodiment described above.

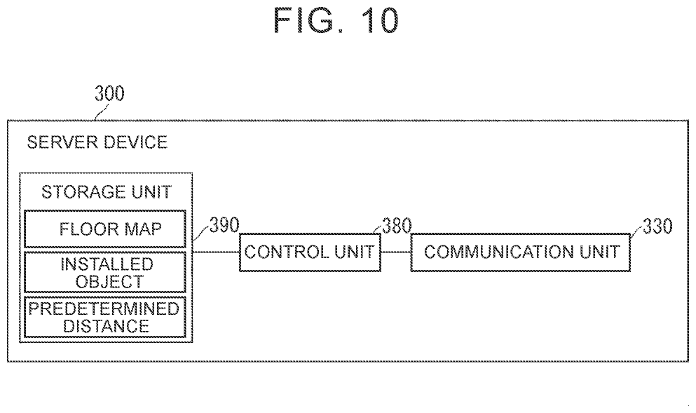

FIG. 10 is a block diagram illustrating the server device according to the second embodiment. As shown in FIG. 10, the server device 300 includes a communication unit 330, a control unit 380, and a storage unit 390.

The communication unit 330 communicates with the mobile robot 100 and the facility camera 400 individually. The communication unit 330 outputs a signal received from each configuration, to the control unit 380. Further, the communication unit 330 appropriately transmits a signal output from the control unit 380, to each configuration. The communication unit 330 may include a router device for performing communication between a plurality of the mobile robots 100 and the facility camera 400. The communication unit 330 may include a plurality of communication means different for each component to communicate with a plurality of the mobile robots 100 and the facility camera 400. The communication unit 330 may be communicably connected to each configuration via an intranet line or the Internet line.

The communication unit 330 may receive the information on the obstacle detected by the mobile robot 100 from the mobile robot 100. Further, the communication unit 330 may receive the image data of the obstacle captured by the facility camera 400 from the facility camera 400. The communication unit 330 outputs the received information on the obstacle to the control unit 380. Further, the communication unit 330 may receive the information on the kind of the obstacle and the information on the predetermined distance 906 set according to the kind of the obstacle that have been determined by the control unit 380 and transmit the information to the mobile robot 100.

The control unit 380 is configured by an arithmetic device such as a CPU and executes various types of information processing. The control unit 380 may detect the obstacle from the information of the mobile robot 100 and the facility camera 400. Further, the control unit 380 may measure the distance from the obstacle, or may determine the kind of the obstacle and the predetermined distance 906 according to the kind of the obstacle, from the information on the obstacle.

The storage unit 390 includes a non-volatile memory such as a flash memory and an SSD. The storage unit 390 stores the floor map of the facility used by the mobile robot 100 for the autonomous movement. Further, the storage unit 390 stores the information on the obstacle, the information on the installed object 905, and the predetermined distance 906 set according to the kind of the obstacle. The storage unit 390 is connected to the control unit 380, and outputs stored information to the control unit 380 in response to a request from the control unit 380.

Operation of Autonomous Mobile System

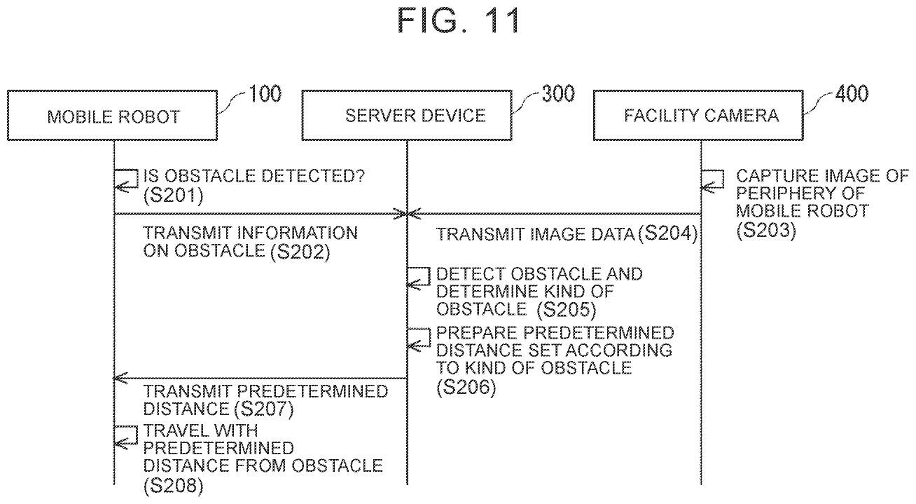

Next, the operation of the autonomous mobile system will be described. FIG. 11 is a sequence diagram illustrating a movement method of the mobile robot 100 in the facility 900 according to the second embodiment. As shown in step S201 of FIG. 11, the mobile robot 100 determines whether an obstacle has been detected. For example, the control unit 180 of the mobile robot 100 determines whether the sensor group 160 has detected the obstacle in the aisle 902. In step S201, when the obstacle has not been detected, step S201 is repeated.

In contrast, when the obstacle has been detected in step S201, the mobile robot 100 transmits the information on the obstacle to the server device 300 as shown in step S202. For example, the communication unit 130 of the mobile robot 100 transmits the information on the obstacle detected by the sensor group 160 to the communication unit 330 of the server device 300. In response to this, the server device 300 receives the information on the obstacle.

Further, as shown in step S203, the facility camera 400 may capture an image of the periphery of the mobile robot 100. Then, as shown in step S204, the facility camera 400 may transmit the captured image data to the server device 300.

Next, as shown in step S205, the server device 300 determines the kind of the obstacle from the information on the obstacle received from the mobile robot 100. The server device 300 may detect the obstacle from the image data of the facility camera 400. The server device 300 may then determine the kind of the obstacle that has been detected.

Next, as shown in step S206, the server device 300 prepares the predetermined distance 906 set according to the kind of the obstacle. For example, the control unit 380 obtains the predetermined distance 906 from the storage unit 390. The predetermined distance 906 may be stored in the storage unit 390 in advance.

Next, as shown in step S207, the server device 300 transmits the prepared predetermined distance 906 to the mobile robot 100. For example, the communication unit 330 of the server device 300 transmits the prepared predetermined distance 906 to the communication unit 130 of the mobile robot 100. In response to this, the mobile robot 100 receives the predetermined distance 906.

Subsequently, as shown in step S208, the mobile robot 100 travels with the predetermined distance 906 from the obstacle. According to the present embodiment, since the server device 300 determines the kind of the obstacle and prepares the predetermined distance 906, the burden on the mobile robot 100 can be reduced and the processing speed of the mobile robot 100 can be improved.

### First Modification of Second Embodiment

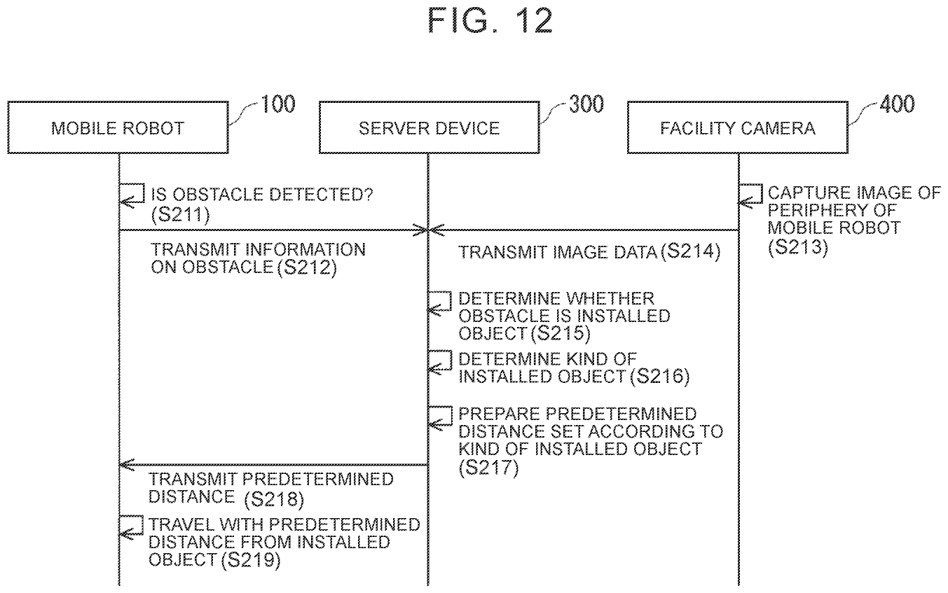

Next, a first modification will be described. The first modification is an example in which the obstacle is the installed object 905. FIG. 12 is a sequence diagram illustrating a movement method of the mobile robot 100 in the facility 900 according to a first modification of the second embodiment.

As shown in step S211 of FIG. 12, the mobile robot 100 determines whether an obstacle has been detected. In step S211, when the obstacle has not been detected, step S211 is repeated.

In contrast, when the obstacle has been detected in step S211, the mobile robot 100 transmits the information on the obstacle to the server device 300 as shown in step S212. In response to this, the server device 300 receives the information on the obstacle.

Further, as shown in step S213, the facility camera 400 may capture an image of the periphery of the mobile robot 100. Then, as shown in step S214, the facility camera 400 may transmit the captured image data to the server device 300.

Next, as shown in step S215, the server device 300 determines whether the obstacle received from the mobile robot 100 is an installed object from the information on the obstacle received from the mobile robot 100. The server device 300 may detect the obstacle from the image data of the facility camera 400 and determine whether the detected obstacle is an installed object. In step S215, when the obstacle is not the installed object 905, the process proceeds to step 205 of FIG. 11 described above.

In contrast, when the obstacle is the installed object 905 in step S215, the kind of the installed object 905 is determined as shown in step S216. For example, the control unit 380 of the server device 300 determines the kind of the installed object 905 by comparing with the information of the installed object 905 stored in the storage unit 390.

Next, as shown in step S217, the server device 300 prepares the predetermined distance 906 set according to the kind of the installed object 905. For example, the control unit 380 obtains the predetermined distance 906 set according to the kind of the installed object 905, from the storage unit 390.

Next, as shown in step S218, the server device 300 transmits the prepared predetermined distance 906 to the mobile robot 100. For example, the communication unit 330 of the server device 300 transmits the prepared predetermined distance 906 to the communication unit 130 of the mobile robot 100. In response to this, the mobile robot 100 receives the predetermined distance 906.

Subsequently, as shown in step S219, the mobile robot 100 travels with the predetermined distance 906 from the installed object 905. According to the present modification, the movement efficiency of the mobile robot 100 can be improved while suppressing the interference with the installed object 905.

### Second Modification of Second Embodiment

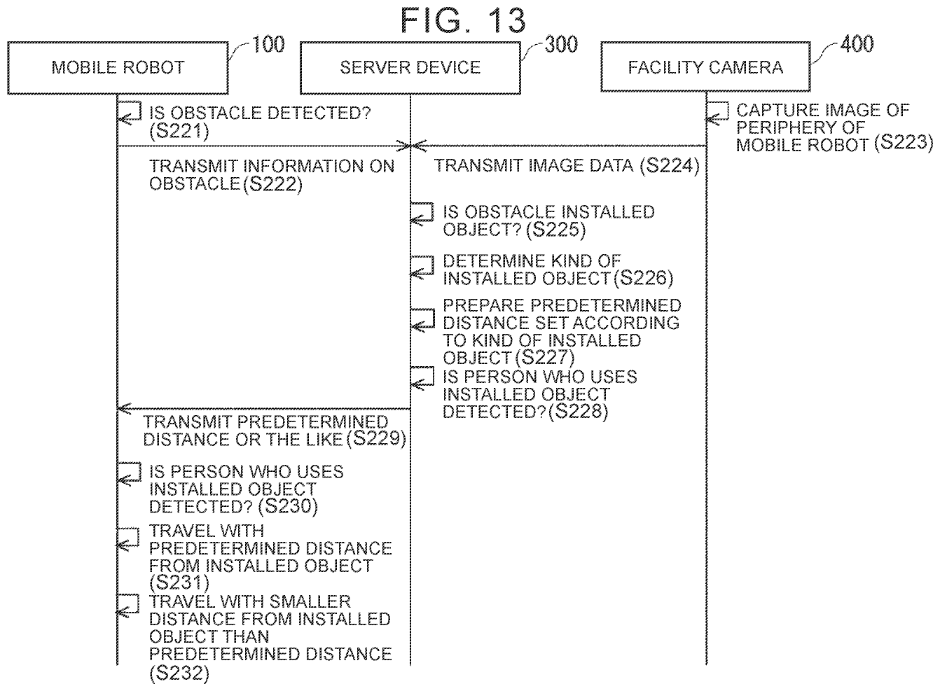

Next, a second modification will be described. The second modification is a method of distinguishing the case where there is a person 907 who uses the installed object 905 and the case where there is no person 907 who uses the installed object 905, when the obstacle is the installed object 905. FIG. 13 is a sequence diagram illustrating a movement method of the mobile robot 100 in the facility 900 according to the second modification of the second embodiment.

Steps S221 to S227 of FIG. 13 are the same as steps S211 to S217 described above.

As shown in step S228, the server device 300 may detect whether there is a person 907 who uses the installed object 905. For example, the control unit 380 of the server device 300 may detect from the image of the facility camera 400 whether there is a person 907 who uses the installed object 905.

Next, as shown in step S229, the server device 300 transmits the prepared predetermined distance 906 to the mobile robot 100. At that time, the server device 300 may transmit to the mobile robot 100 information including whether there is a person 907 who uses the installed object 905 as the predetermined distance or the like. In response to this, the mobile robot 100 receives the predetermined distance or the like.

Next, as shown in step S230, the mobile robot 100 determines whether a person 907 who uses the installed object 905 has been detected. For example, the control unit 180 of the mobile robot 100 determines whether a person 907 who uses the installed object 905 has been detected from the information on the installed object 905 detected by the sensor group 160. Alternatively, the control unit 180 of the mobile robot 100 may determine whether a person 907 who uses the installed object 905 has been detected from the information on the predetermined distance or the like received from the server device 300.

When a person 907 who uses the installed object 905 has been detected in step S230, the mobile robot 100 travels with the predetermined distance 906 from the installed object 905 as shown in step S231.

In contrast, when a person 907 who uses the installed object 905 has not been detected in step S230, the mobile robot 100 travels with a smaller distance from the installed object 905 than the predetermined distance 906 as shown in step S232. According to the present modification, the movement efficiency of the mobile robot 100 can be further improved.

### Third Modification of Second Embodiment

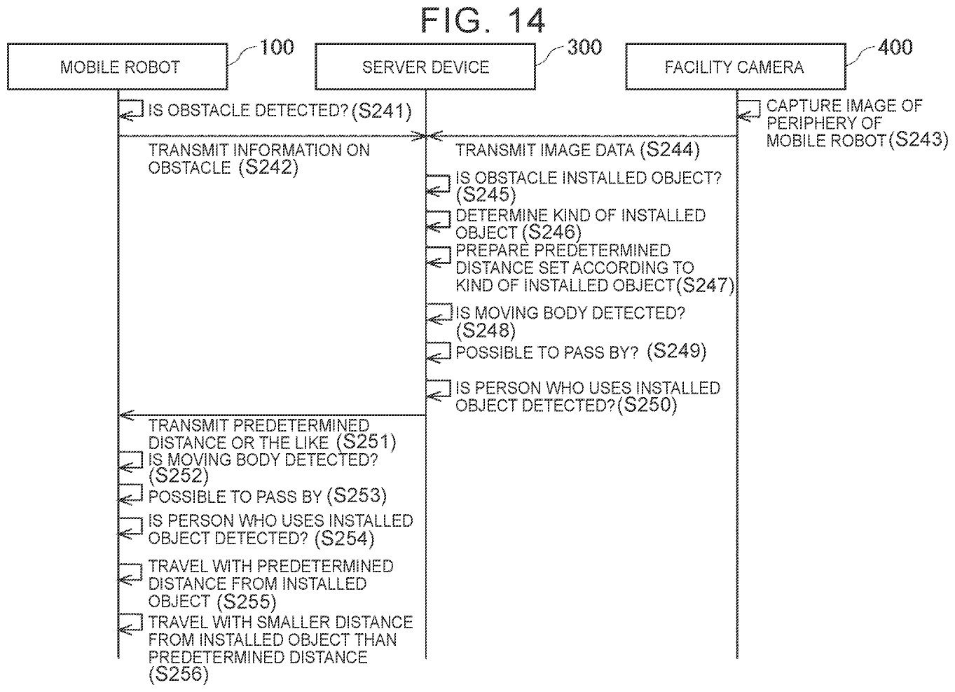

Next, a third modification will be described. The third modification is a method of passing by the moving body 904 when the obstacle is the installed object 905. FIG. 14 is a sequence diagram illustrating a movement method of the mobile robot 100 in the facility 900 according to the third modification of the second embodiment.

Steps S241 to S247 of FIG. 14 are the same as steps S221 to S227 described above.

As shown in step S248, the server device 300 may detect the moving body 904. For example, the control unit 380 of the server device 300 may detect whether there is a moving body 904 from the image of the facility camera 400. Then, as shown in step S249, when there is a moving body 904, the server device 300 may determine whether it is possible to pass by each other. Further, as shown in step S250, the server device 300 may detect whether there is a person 907 who uses the installed object 905.

Next, as shown in step S251, the server device 300 transmits the prepared predetermined distance 906 to the mobile robot 100. At that time, the server device 300 may transmit to the mobile robot 100 information including whether there is a moving body 904, whether the mobile robot 100 can pass by the moving body 904, and whether there is a person 907 who uses the installed object 905, as the predetermined distance or the like. In response to this, the mobile robot 100 receives the predetermined distance or the like.

Subsequently, as shown in step S252, the mobile robot 100 determines whether the moving body 904 has been detected. For example, the control unit 180 of the mobile robot 100 determines whether the sensor group 160 has detected the moving body 904. Alternatively, the control unit 180 of the mobile robot 100 may determine whether there is a moving body 904 from the information on the predetermined distance or the like received from the server device 300. When the moving body 904 has not been detected in step S252, the process proceeds to step S219 of FIG. 12 or step S230 of FIG. 13.

In contrast, when the moving body 904 has been detected in step S252, the mobile robot 100 determines whether it is possible to pass by the moving body 904 as shown in step S253. In step S253, when the mobile robot 100 cannot pass by the moving body 904, the mobile robot 100 performs a predetermined process. For example, the mobile robot 100 may stop at the edge of the aisle 902, or may go back in the aisle 902.

In contrast, when it is possible to pass by the moving body 904 in step S253, it is determined whether a person 907 who uses the installed object 905 has been detected as shown in step S254. For example, the control unit 180 of the mobile robot 100 determines whether a person 907 who uses the installed object 905 has been detected from the information on the installed object 905 detected by the sensor group 160. Alternatively, the control unit 180 of the mobile robot 100 may determine whether there is a person 907 who uses the installed object 905 from the information on the predetermined distance or the like received from the server device 300.

When a person 907 who uses the installed object 905 has been detected in step S254, the mobile robot 100 travels with the predetermined distance 906 from the installed object 905 as shown in step S255.

In contrast, when a person 907 who uses the installed object 905 has not been detected in step S254, the mobile robot 100 travels with a smaller distance from the installed object 905 than the predetermined distance 906 as shown in step S256. According to the present modification, even when passing by the moving body 904, the movement efficiency of the mobile robot 100 can be improved while suppressing the interference with the installed object 905.

The present disclosure is not limited to the above embodiments, and can be appropriately modified without departing from the spirit. For example, a combination of the configurations of the first and second embodiments is also included in the scope of the technical idea of the present embodiment. In addition, the autonomous mobile method, autonomous mobile program, and a storage medium storing the autonomous mobile program described below are also included in the scope of the technical idea of the present embodiment.

### Appendix 1

An autonomous mobile method for an autonomous mobile device that autonomously moves in a facility provided with an aisle, the autonomous mobile method comprising:

a step of determining a kind of an obstacle when the autonomous mobile device detects the obstacle in the aisle where the autonomous mobile device travels;
a step of preparing a predetermined distance set according to the kind of the obstacle; and
a step of traveling with the predetermined distance from the obstacle.

### Appendix 2

The autonomous mobile method according to Appendix 1, wherein:

the obstacle is an installed object installed in the aisle to be used by a person; and
the predetermined distance is a distance for the person to use the installed object.

### Appendix 3

The autonomous mobile method according to Appendix 2, wherein the installed object includes at least one of a handrail, a bench, and a bulletin board.

### Appendix 4

The autonomous mobile method according to Appendix 2 or 3, wherein when detecting the person who uses the installed object, a speed of autonomous movement is changed.

### Appendix 5

The autonomous mobile method according to any one of Appendices 2 to 4, wherein when a predetermined moving body approaches and the person who uses the installed object is not detected, traveling is performed with a smaller distance from the installed object than the predetermined distance.

### Appendix 6

An autonomous mobile program for an autonomous mobile device that autonomously moves in a facility provided with an aisle, the autonomous mobile program causing a computer to execute:

determination of a kind of an obstacle when the autonomous mobile device detects the obstacle in the aisle where the autonomous mobile device travels;
preparation of a predetermined distance set according to the kind of the obstacle; and
traveling with the predetermined distance from the obstacle.

### Appendix 7

The autonomous mobile program according to Appendix 6, wherein:

the obstacle is an installed object installed in the aisle to be used by a person; and
the predetermined distance is a distance for the person to use the installed object.

### Appendix 8

The autonomous mobile program according to Appendix 7, wherein the installed object includes at least one of a handrail, a bench, and a bulletin board.

### Appendix 9

The autonomous mobile program according to Appendix 7 or 8, causing the computer to execute change in a speed of autonomous movement when the person who uses the installed object is detected.

### Appendix 10

The autonomous mobile program according to any one of Appendices 7 to 9, causing the computer to execute traveling with a smaller distance from the installed object than the predetermined distance when a predetermined moving body approaches and the person who uses the installed object is not detected.

What is claimed is:

1. An autonomous mobile system that autonomously moves in a facility, the autonomous mobile system comprising:
obstacle detection means for detecting an obstacle in an aisle;
distance measurement means for measuring a distance from the obstacle;
obstacle determination means for determining a kind of the obstacle; and
storage means for storing a predetermined distance set according to the kind of the obstacle, wherein the autonomous mobile system travels with the predetermined distance from the obstacle depending on the kind of the obstacle.

2. An autonomous mobile system including an autonomous mobile device that autonomously moves in a facility, wherein when there is an obstacle in an aisle where the autonomous mobile device travels, the autonomous mobile device travels with a predetermined distance set according to a kind of the obstacle, from the obstacle.

3. The autonomous mobile system according to claim 2, further comprising a server device that transmits and receives traveling information to and from the autonomous mobile device, wherein the server device includes, of the autonomous mobile system, at least one of:
obstacle detection means for detecting the obstacle in the aisle;
distance measurement means for measuring a distance from the obstacle;
obstacle determination means for determining the kind of the obstacle; and
storage means for storing the predetermined distance set according to the kind of the obstacle.

4. The autonomous mobile system according to claim 1, wherein:
the obstacle is an installed object installed in the aisle to be used by a person; and
the predetermined distance is a distance for the person to use the installed object.

5. The autonomous mobile system according to claim 4, wherein the installed object includes at least one of a handrail, a bench, and a bulletin board.

6. The autonomous mobile system according to claim 4, wherein when detecting the person who uses the installed object, the autonomous mobile system changes a speed of autonomous movement.

7. The autonomous mobile system according to claim 4, wherein when a predetermined moving body approaches and the autonomous mobile system does not detect the person who uses the installed object, the autonomous mobile system travels with a smaller distance from the installed object than the predetermined distance.

8. An autonomous mobile method for an autonomous mobile device that autonomously moves in a facility provided with an aisle, the autonomous mobile method comprising:
a step of determining a kind of an obstacle when the autonomous mobile device detects the obstacle in the aisle where the autonomous mobile device travels;
a step of preparing a predetermined distance set according to the kind of the obstacle; and
a step of traveling with the predetermined distance from the obstacle.

9. A non-transitory storage medium that stores an autonomous mobile program for an autonomous mobile device that autonomously moves in a facility provided with an aisle, the autonomous mobile program causing a computer to execute:
determination of a kind of an obstacle when the autonomous mobile device detects the obstacle in the aisle where the autonomous mobile device travels;
preparation of a predetermined distance set according to the kind of the obstacle; and
traveling with the predetermined distance from the obstacle.
